(19) United States
(12) Patent Application Publication
(10) Pub. No.: US 2013/0326895 A1
(43) Pub. Date: Dec. 12, 2013

(54) Extendable Level

(71) Applicant: George Bureau, North Woodstock, NH (US)

(72) Inventor: George Bureau, North Woodstock, NH (US)

(21) Appl. No.: 13/900,679

(22) Filed: May 23, 2013

Related U.S. Application Data
(60) Provisional application No. 61/657,094, filed on Jun. 8, 2012.

(51) Int. Cl. G01C 9/26

(52) U.S. Cl. CPC G01C 9/26
USPC 33/381; 33/379

(57) ABSTRACT

This invention relates to an extendable level device wherein the user may selectively reposition a level portion relative to a frame portion between a compact arrangement and an extended arrangement, and anywhere in between with relative ease and accuracy. In a preferred embodiment of the present invention, the extendable level device is comprised of a level portion that slides in and out of a housing frame, and a locking device for temporarily securing said level portion in a desired position relative to the housing frame. The interplay of the level portion and the housing frame enables the user to both (i) use, transport and/or store the device in its compact arrangement, and (ii) create a longer level device, by sliding the level portion partially out of said frame portion, when the user must level or plum a span that exceeds the length of traditional levels.

### CROSS-REFERENCE

This application claims priority from Provisional Patent Application Ser. No. 61/657,094 filed on Jun. 8, 2012.

### FIELD OF THE INVENTION

This invention relates to an extendable level device wherein the user may selectively reposition the level between a compact arrangement and an extended arrangement, and anywhere in between, with relative ease and accuracy.

### BACKGROUND

Levels are designed to indicate to a user whether a surface is horizontal (level) or vertical (plumb). Levels are commonly used by homeowners and tradesman, such as contractors, carpenters, plumbers, stonemasons, bricklayers and the like, to determine whether a particular surface is level or plum and to ensure the accuracy of their work. Unfortunately, most levels are relatively short in length to facilitate easy transportation and storage, and may be difficult to use over relatively long spans. When a long span is encountered (long being defined as a length greater than the overall length of the level itself), the user must typically apply the level to a first span and then reposition the level to an adjacent span, and so on and so forth until the level has been applied to the entire span. However, this process can be time-consuming and tiring for the user. It may also lead to inaccurate results and unnecessary errors.

Consequently, there is a long felt need in the art for a an extendable level that permits a user to selectively reposition the level between a compact arrangement, wherein the level is approximately the same length as existing levels thereby facilitating relatively easy transportation and storage, and an extended arrangement, wherein the level is capable of extending across longer spans than traditional levels. There is also a long felt need for a extendable level device that enables a user to secure the level in a compact or extended arrangement, or any position in between, while the user is applying the level of the present invention to a surface. Finally, there is a long felt need for an extendable level device that accomplishes all of the forgoing objectives, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is an extendable level device that enables a user to selectively reposition the level between a compact arrangement, wherein the level is approximately the same length as existing levels thereby facilitating relatively easy transportation and storage, and an extended arrangement, wherein the level is capable of extending across longer spans than traditional levels. The improved leveling device also enables a user to secure the level in a compact or extended arrangement, or any position in between, while the user is applying the level of the present invention to a work surface. The extendable level is preferably comprised of a level, a housing frame and a locking device, wherein the level may be selectively repositioned relative to the housing frame and temporarily locked in a desired position so that the level may be used for its intended purpose.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of a preferred embodiment of the level portion of the extendable level device of the present invention.

FIG. 1A is an end elevational view of the level portion of the extendable level device of the present invention.

FIG. 2 is a perspective view of a preferred embodiment of the housing frame of the extendable level device of the present invention.

FIG. 2A is an end elevational view of the housing frame of the extendable level device of the present invention.

FIG. 3 is a perspective view of a preferred embodiment of the extendable level device of the present invention in a partially extended arrangement.

FIG. 4 is a front elevational view of the extendable level device of the present invention in a partially extended arrangement and being used by a user.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

The extendable level device 100 of the present invention is preferably comprised of a level portion 110, a housing frame 160, wherein said level portion 110 is slidably repositionable relative to said housing frame 160, and a locking mechanism 190 for temporarily securing said level portion 110 in a desired position relative to said housing frame 160. In a preferred embodiment of the present invention, extendable level device 100 may further comprise a ball bearing device 180 for more easily facilitating the sliding of level portion 110 in and out of housing frame 160, as explained more fully below.

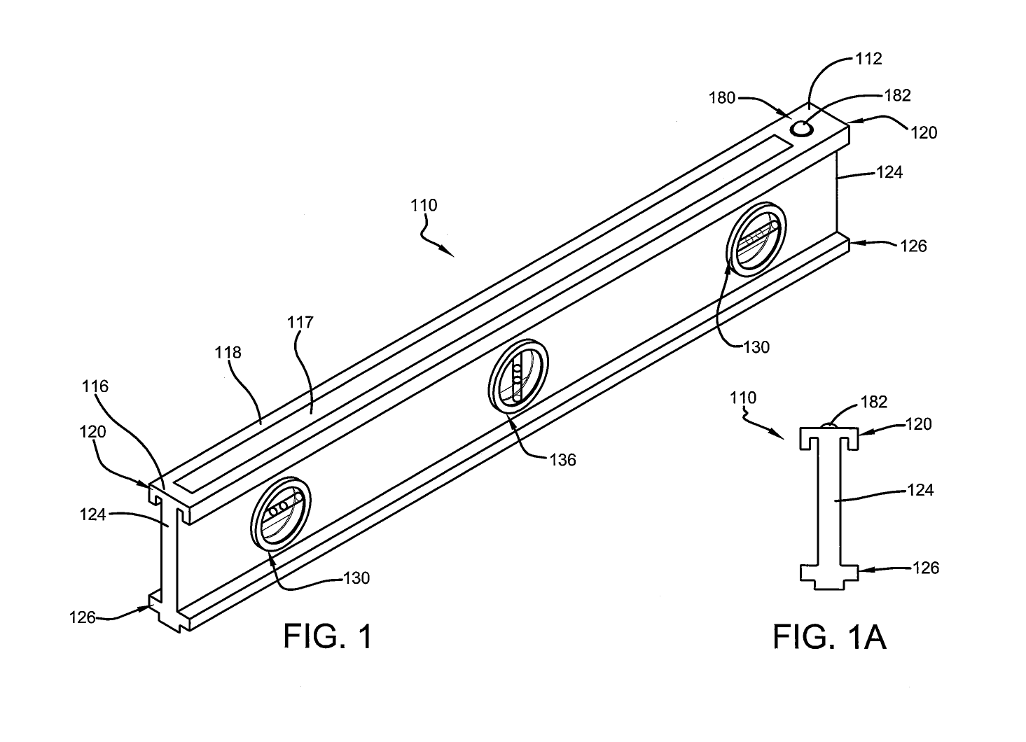

Referring to the drawings, FIG. 1 illustrates a perspective view of a preferred embodiment of level portion 110 which is an elongated member comprised of an inboard end 112 (inboard referring to the end of level portion 110 nearest to housing frame 160), an opposing outboard end 116, a top rail 120, a body portion 124, a bottom rail 126 and one or more horizontal levels 130 and/or vertical levels 136 positioned along said level portion 110. Top rail 120, body portion 124, and bottom rail 126 are preferably integrally formed and extend the entire length of level portion 110 from inboard end 112 to outboard end 116.

FIG. 1A illustrates a side elevational view of a preferred embodiment of level portion 110, wherein the top rail 120 and body portion 124 give the general appearance of a capitalized “T”, and the body portion 124 and bottom rail 126 give the general appearance of an inverted lowercase “t”. Notwithstanding, it is contemplated that other shapes could also be used without affecting the overall concept of the present invention, provided that the shape of level portion 110 corresponds to the shape of housing frame 160 as explained more fully below. Level portion 110 is preferably comprised of metal, though it is contemplated that other durable materials such as fiberglass, plastic and the like could also be used. In a preferred embodiment of the present invention level portion 110 further comprises a metal strip or plate 117 positioned along a top surface 118 of level portion 110 as shown in FIG. 1, the purpose of which is described more fully below.

The overall length of level portion 110, as measured from inboard end 112 to outboard end 116, is preferably between 30 and 54 inches, though it is contemplated that level portion 110 could be manufactured to other lengths to suit user preference or for a particular application. As shown in FIG. 1, both the top rail 124 and the bottom rail 126 extend the length of level portion 110, from inboard end 112 to outboard end 116.

As previously stated and as illustrated in FIG. 1, level portion 110 may also comprise one or more horizontal levels 130 and/or vertical levels 136. The composition and use of levels 130, 136 are well known in the art and levels 130, 136 may be any type of commercially available level known in art, although bubble indicator levels are preferred. FIG. 1 illustrates two horizontal bubble indicator levels 130 and one vertical bubble indicator level 136, each of which is well known in the art, in spaced apart relationship along the length of body portion 124. Horizontal levels 130 are useful in determining whether a horizontal surface or object is level and vertical levels 136 are useful in determining whether a vertical surface or object is plumb.

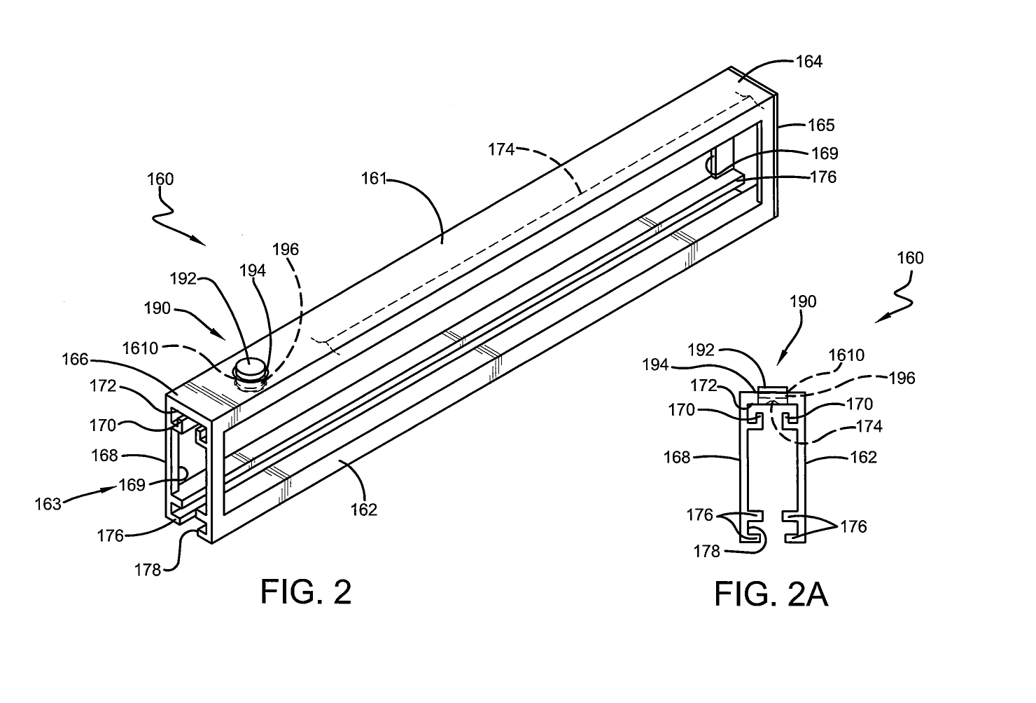

FIG. 2 is a perspective view of a preferred embodiment of housing frame 160, which is comprised of a top 161 with a continuous opening 1610 therein for receipt of locking mechanism 190 as explained more fully below, a front 162, a first end 164 and first end plate 165, an opposing second end 166, a back 168, an upper track 170 that forms an upper track channel or opening 172, and a lower track 176 that forms a lower track channel or opening 178. As shown in FIG. 2, both the upper track 170 and the upper track opening 172 formed thereby, as well as the lower track 176 and the lower track opening 178 formed thereby, extend the length of housing frame 160 from first end 164 to second end 166. Front 162 and back 168 are each further comprised of an opening 163, 169 respectively for viewing level portion 110, and horizontal and vertical levels 130, 136 in particular. In a preferred embodiment of the present invention, housing frame 160 further comprises a groove 174 therein for interaction with ball bearing device 180, as described more fully below and illustrated in the FIGS. Groove 174 extends substantially along the length of housing frame 160 beneath top 161 and above upper track opening 172, but terminates approximately six inches from the second end 166 to prevent level portion 110 from becoming separated from housing frame 160.

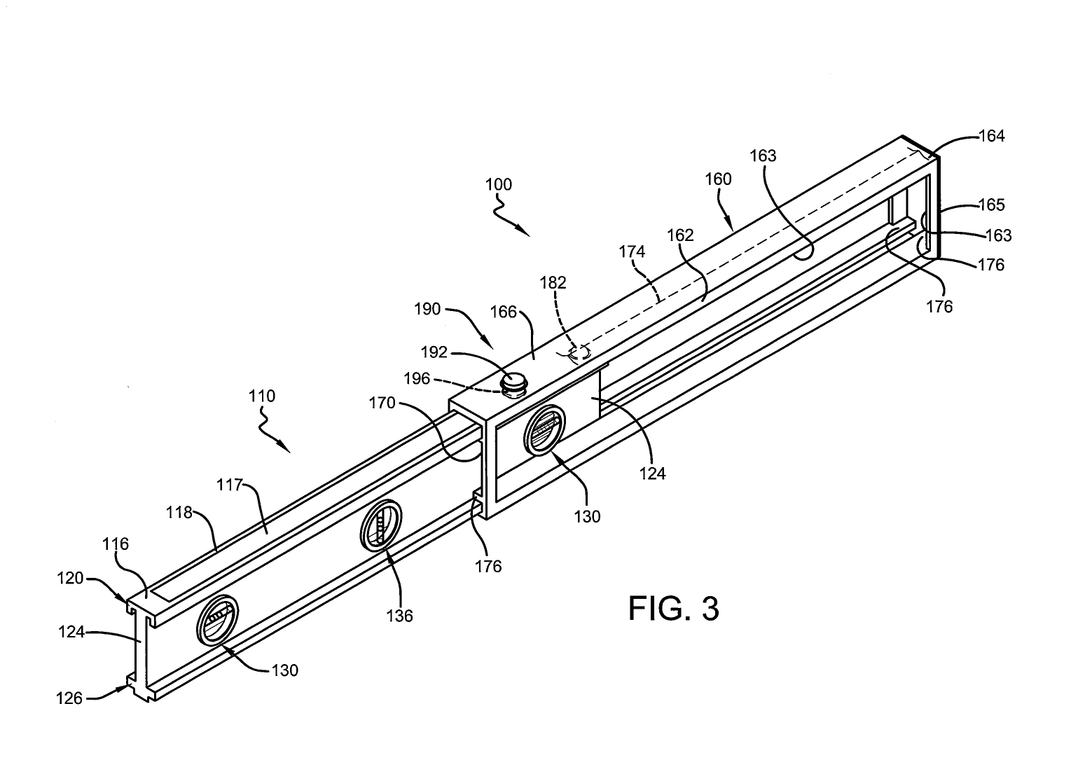

FIG. 2A illustrates a side elevational view of a preferred embodiment of housing frame 160, wherein front 162, back 168 and upper track 170 form continuous upper track opening 172, which extends the length of housing frame 160 from first end 164 to second end 166, for receipt of top rail 120. Similarly, front 162, back 168 and lower track 176 form continuous lower track opening 178, which also extends the length of housing frame 160 from first end 164 to second end 166, for receipt of bottom rail 126. Importantly, the FIGS. illustrate only one potential embodiment of the cross-sectional shape of top and bottom rails 120, 126, upper and lower tracks 170, 176, and upper and lower track openings 172, 178. However, it is contemplated that other cross-sectional shapes and/or configurations can also be used provided that the shape, size and configuration of upper tracks 170 and upper track opening 172 correspond to and are capable of receiving top rail 120, and further provided that the shape, size and configuration of lower tracks 176 and lower track opening 178 correspond to and are capable of receiving bottom rail 126, as best illustrated in FIG. 3.

Ball bearing device 180 further comprises a metal ball 182 that is retained in a pocket 184 preferably located on the top surface 118 of level portion 110 near the inboard end 112, as best illustrated in FIG. 1. More specifically, ball 182 functions like a typical ball bearing and protrudes out of pocket 184 and above top surface 118 for engagement with groove 174 in housing frame 160. As level portion 110 is extended outwardly from housing portion 160, ball 182 rotates within pocket 184 and travels along groove 174, thereby helping to facilitate the movement of level portion 110 relative to housing frame 160. However, as previously mentioned, because groove 174 does not extend the entire length of housing frame 160 (it preferably terminates approximately 6 inches from second end 166), ball 182 prevents level portion 110 from separating from housing frame 160. Likewise, the presence of plate 165 on the first end 164 of housing frame 160 prevents level portion 110 from separating from housing frame 160 in the opposite direction.

Locking mechanism 190 is preferably a spring loaded button magnet positioned along the top 161 of housing frame 160. More specifically, spring loaded button magnet is comprised of a button 192, a spring 194 attached to said button 192, and a magnet 196 attached to said spring 194, as shown in FIG. 2. Spring loaded buttons are well known in the art and typically engage with a single press by a user and disengage with a second press. A user (not shown) desiring to temporarily lock level portion 110 in a particular position relative to housing frame 160 (e.g., in an extended arrangement) would simply depress button 192 once thereby causing spring 194 to move magnet 196 through opening 1610 in top 161 and engage metal plate 117 on level portion 110 thereby creating a magnetic connection between level portion 110 and housing portion 160. When the user (not shown) desires to unlock locking mechanism 190, he or she would simply depress button 192 a second time thereby breaking the magnetic attraction by pulling magnet 196 away from metal plate 117. Of course it is contemplated that other locking mechanisms could also be used, such as a button or lever that causes a temporary friction fit between level portion 110 and housing frame 160 similar to the technology applied to self-locking tape measures, without affecting the overall concept of the present invention.

FIG. 3 illustrates a perspective view of a preferred embodiment of the extendable level device 100 of the present invention in a partially extended arrangement, meaning that level portion 110 extends outwardly from second end 166 of housing frame 160. Level portion 110 is selectively repositionable between a compact arrangement, wherein level portion 110 fits entirely or almost entirely within housing frame 160, and an extended arrangement, wherein the outboard end 116 of said level portion 110 is slid in a direction away from housing frame 160 so as to effectively lengthen the overall length of extendable level device 100. More specifically, top rail 120 slides on upper tracks 170 and within upper track opening 172, and bottom rail 126 slides on lower tracks 176 within lower track opening 178. Further, ball bearing device 180 helps facilitate the sliding of level portion 110 in and out of housing frame 160 as described above, and locking mechanism 190 allows the user to selectively and temporarily lock level portion 110 in a particular position relative to housing frame 160. When the extendable level device is in an extended arrangement, the overall length of the device is preferably between 48 and 96 inches.

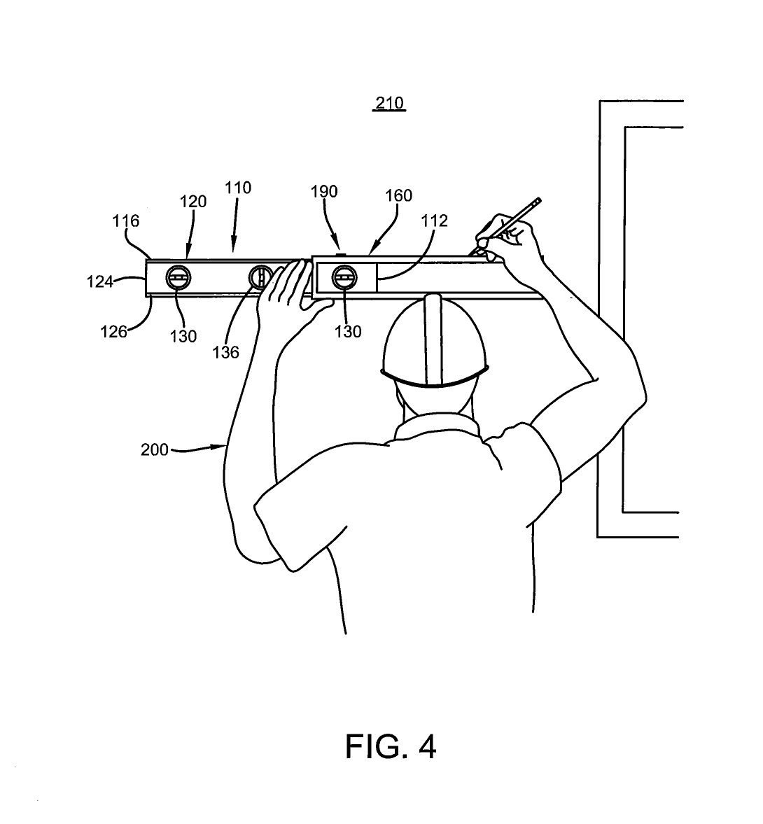

Having described the overall structure of extendable level device 100 of the present invention, it's use and usefulness will now be described. FIG. 4 is a front elevational view of a user 200 using extendable level device 100 in a partially extended arrangement to determine if surface 210 is level. More specifically, user 200 may store, transport and use level device 100 in a compact arrangement, wherein level portion 110 fits entirely or almost entirely within housing frame 160, and horizontal and vertical levels 130, 136 of level portion 110 may be viewed through one or more of opening 163 in front surface 162 and opening 169 in back surface 168 of housing frame 160 level. Nonetheless, when the overall length of the surface being leveled or plumbed exceeds the overall length of level device 100 in its compact arrangement, user 200 can increase the overall length of level device 100 by sliding level portion 110 out of housing frame 160 on upper and lower tracks 170, 176, respectively. More specifically, top rail 120 slides on upper tracks 170 and within upper track opening 172, and bottom rail 126 slides on lower tracks 176 within lower track opening 178. As previously described, ball bearing device 180 helps facilitate the sliding of level portion 110 in and out of housing frame 160, and locking mechanism 190 allows the user to selectively and temporarily lock level portion 110 in a particular position relative to housing frame 160.

Consequently, the extendable level device enables a user to selectively reposition a level portion relative to a frame portion between a compact arrangement and an extended arrangement, and anywhere in between with relative ease and accuracy. More specifically, the extendable level device of the present invention enables the user to both (i) use, transport and/or store the device in its compact arrangement, and (ii) create a longer level device, by sliding the level portion partially out of the frame portion, when the user must level or plum a span that exceeds the length of traditional levels. Finally, the extendable level device of the present invention is relatively inexpensive to manufacture and safe and easy to use.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An extendable level device comprising:
a level portion; and
a housing frame.

2. The extendable level device of claim 1, wherein said level portion is selectively repositionable between a compact arrangement and an extended arrangement relative to said housing frame.

3. The extendable level device of claim 1, wherein said extendable level device further comprises a locking mechanism.

4. The extendable level device of claim 1, wherein said housing frame further comprises at least one of an upper track and a lower track.

5. The extendable level device of claim 1, wherein said housing level portion further comprises at least one bubble indicator.

6. The extendable level device of claim 5, wherein said at least one bubble indicator is a horizontal level.

7. The extendable level device of claim 5, wherein said at least one bubble indicator is a vertical level.

8. The extendable level device of claim 1, wherein said extendable level device comprises at least one ball bearing.

9. An extendable level device comprising:
a level portion comprised of at least one level;
a housing frame comprised of an upper track and a lower track;
at least one ball bearing for selectively repositioning said level portion relative to said housing frame; and
a locking mechanism for securing said level portion in a desired position relative to said housing frame.

10. The extendable level device of claim 9, wherein said level portion is selectively repositionable between a compact arrangement and an extended arrangement relative to said housing frame.

11. The extendable level device of claim 9, wherein said locking mechanism is a magnet.

12. The extendable level device of claim 9, wherein said level portion further comprises a top rail portion for engaging said upper track and a bottom rail portion for engaging said lower track.

13. The extendable level device of claim 9, wherein said at least one level is a bubble indicator level.

14. The extendable level device of claim 9, wherein said level portion is comprised of at least one horizontal level and one vertical level.

15. An extendable level device comprising:
a level portion comprised of at least one horizontal level, at least one vertical level, a top rail portion and a bottom rail portion;
a housing frame comprised of an upper track and a lower track;
at least one ball bearing for selectively repositioning said level portion relative to said housing frame; and
a locking mechanism for securing said level portion in a desired position relative to said housing frame.

16. The extendable level device of claim 15, wherein said level portion is selectively repositionable between a compact arrangement and an extended arrangement relative to said housing frame.

17. The extendable level device of claim 15, wherein said locking mechanism is a magnet.

18. The extendable level device of claim 15, wherein said top rail portion engages said upper track and said bottom rail portion engages said lower track.

19. The extendable level device of claim 15 wherein said at least one ball bearing is retained in a pocket attached to said level portion and wherein said at least one ball bearing engages a groove in said housing frame.

20. The extendable level device of claim 16 wherein said extendable level device is between 48 and 96 inches in length when in the extended arrangement.
